(19) United States
(12) Patent Application Publication
(10) Pub. No.: US 2005/0213930 A1
(43) Pub. Date: Sep. 29, 2005

(54) Electronic terminal apparatus

(75) Inventors: Meeko Kuwahara, Yokohama (JP); Junji Shiokawa, Chigasaki (JP)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Hitachi, Ltd., Tokyo (JP)

(21) Appl. No.: 10/847,777

(22) Filed: May 17, 2004

(30) Foreign Application Priority Data
Mar. 24, 2004 (JP) 2004-085964

(51) Int. Cl. H04N 5/76

(52) U.S. Cl. 386/46; 386/125

(57) ABSTRACT

An electronic terminal apparatus, for processing information provided from a recording/reproducing apparatus connected thereto, comprising: a communication interface being configured to send information to the recording/reproducing apparatus and to receive information from the recording/reproducing apparatus; a display portion being configured to display the information provided from the recording/reproducing apparatus; and a control portion being configured to control the electronic terminal apparatus, wherein: when connecting the electronic terminal apparatus to the recording/reproducing apparatus, to which other electronic terminal apparatus is already connected, the control portion receives information relating to a communication condition between the recording/reproducing apparatus and the other electronic terminal apparatus connected thereto, thereby displaying the information relating to the communication condition on the display portion.

### FIELD OF THE INVENTION

The present invention relates to a network technology of enabling transmission of data with using communication technologies.

### BACKGROUND OF THE INVENTION

In general network technologies, when using an electronic apparatus while connecting a plural number of electronic terminal devices or apparatus to the electronic apparatus to be a main apparatus, that main electronic apparatus makes managements/operations upon the other electronic terminal devices or apparatuses.

For example, a network technology is already known, of informing or noticing a specific message from the main electronic apparatus to the other electronic devices or apparatuses, or noticing a fact that other electronic terminal device(s) is/are newly connected thereto, to the electronic terminal apparatuses, which are already connected to the main electronic apparatus, for example, in Japanese Patent Laying-Open No. Hei 7-143175 (1995) and Japanese Patent Laying-Open No. Hei 8-321884 (1996).

### BRIEF SUMMARY OF THE INVENTION

However, with such the conventional technologies mentioned above, though being enable to manage the electronic terminal devices or apparatuses from the main electronic apparatus, which are connected thereto, however it is impossible to set up the communication condition; such as, a transmission rate of data that is transferred from a side of the electronic terminal apparatuses to the main electronic apparatus, etc., and therefore it brings about a bad or inferior usability thereof. Then, an object according to the present invention is to provide a network technology, for enabling to contribute an effective use of an ability of the electronic apparatus, which builds up a network together with the electronic terminal devices or apparatuses, at its maximum, thereby improving the usability thereof.

For accomplishing the object mentioned above, according to the present invention, there is provided to provide an electronic terminal apparatus, for processing information provided from a recording/reproducing apparatus connected thereto, comprising: a communication interface being configured to send information to said recording/reproducing apparatus and to receive information from said recording/reproducing apparatus; a display portion being configured to display the information provided from said recording/reproducing apparatus; and a control portion being configured to control said electronic terminal apparatus, wherein: when connecting said electronic terminal apparatus to said recording/reproducing apparatus, to which other electronic terminal apparatus is already connected, said control portion receives information relating to a communication condition between said recording/reproducing apparatus and said other electronic terminal apparatus connected thereto, thereby displaying the information relating to said communication condition on said display portion.

More preferably, according to the present invention, in the electronic terminal apparatus, as described in the above, when the information cannot be sent from said recording/reproducing apparatus to said other electronic terminal apparatus, said control portion receives information of indicative that the information cannot be sent from said recording/reproducing apparatus, thereby displaying information of indicative that said information cannot be sent, on said display portion.

Also, according to the present invention, more preferably, in the electronic terminal apparatus, as described in the above, said control portion receive information of indicative that said other electronic terminal apparatus is already connected thereto, and displays the information of indicative that said other electronic terminal apparatus is already connected thereto, on said display portion.

Moreover, according to the present invention, in the electronic terminal apparatus, as described in the above, information can be transmitted between said other electronic terminal apparatus through a communication interface of said recording/reproducing apparatus.

### BRIEF DESCRIPTION OF THE SEVERAL VIEWS OF THE DRAWING

Those and other objects, features and advantages of the present invention will become more readily apparent from the following detailed description when taken in conjunction with the accompanying drawings wherein:

FIG. 1 is a block diagram for showing the structure of a first embodiment, according to the present invention;

FIG. 2 shows a flowchart for showing an example of flows, in particular, on a display screen in communication processing within the first embodiment according to the present invention;

FIG. 3 also shows a flowchart for showing an example of the flows, in particular, on the display screen in the communication processing within the first embodiment according to the present invention; and

FIG. 4 is a block diagram for showing the structure of a second embodiment, according to the present invention.

### DETAILED DESCRIPTION OF THE INVENTION

Hereinafter, embodiments according to the present invention will be fully explained, by referring to the attached drawings.

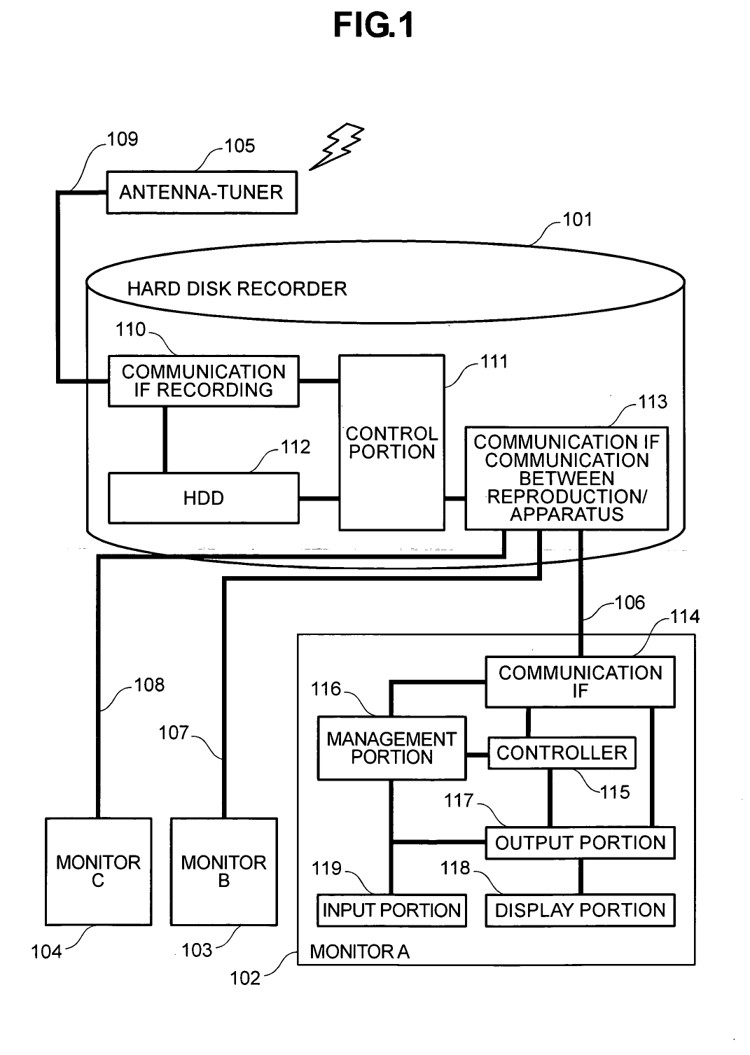

FIG. 1 is a block diagram for showing the structure of a first embodiment, according to the present invention.

In this FIG. 1, a hard disk recorder 101 has a communication function, and thereby it is playing a roll of, such as, a main electronic apparatus, within a network according to the present embodiment. A monitor 102 has also a communication function of being connectable to the hard disk recorder 101, and thereby is playing a role of an electronic terminal device or apparatus within the network according to the present embodiment. To the hard disk recorder 101 are connected, not only a monitor A 102, but also a monitor B 103 and a monitor C 103, for example. An antenna/tuner 105 receives AV (Audio Visual) data from an outside, and it transmits the AV data to the hard disk recorder 101 through a communication path 109.

Within the hard disk recorder 101, a communication interface 110 receives the AV data transmitted from the antenna/tuner 105, and then it transmits them into a hard disk drive (HDD) 112. The HDD 112 records the AV data onto a hard disk, as a recording medium thereof, thereby reserving the data therein. And, it conducts various kinds of transmission of data, including such as the AV data, for example, among the monitor A 102, the monitor B 103 and the monitor C 104, through a communication interface 113. Those operations mentioned above are carried out under the control of a controller 111.

The monitor A 102 is able to transmit the various kinds of data including the AV data, through a communication interface 114. The AV data received through the communication interface 114 is converted within an output portion 117, into a format that can be displayed on a display portion 118, and it is displayed on the display portion 118, as the AV data. A management portion 116 manages the communication condition between the monitor A 102 and the hard disk recorder 101. The monitor A 102 carries out the following operations under the control of a controller 115. Thus, a user can operates the monitor A 102 through operation on an input portion 119. This input portion 119 may be constructed by mounting an operation button(s) and/or a keyboard on the monitor A 102, or it may be a receiver circuit for receiving an operation signal generated by a remote controller, for example. Further, the monitor B 103 and the monitor C 104 also have the structure being similar to that of the monitor A 102. Also, the communication paths 106 to 109 may be made up with, such as, a wire or a radio wave, for example. Each of the control portion 111, the controller 115, the management portion 116 and the output portion 118 may be built up with a circuit for the exclusive use, in the form of hardware, or it may be built-up with, such as, in the form of software, for example, wherein a program is executed upon a CPU (Central Processing Unit) a MPU (Micro Processing Unit) or the like, having a memory therein.

With such the plural number of monitors; i.e., the monitor A 102, the monitor B 103 and the monitor C 104, since the communication interface 113 of the hard disk recorder 101 and the monitor A 102 are connected with each other (also, being same to the monitor B 103 and the monitor C 104) through the communication paths 106, 107 and 108; therefore, it is possible to display the AV data which are reserved within the HDD 112 of the hard disk recorder 101. Also, conducting the communication through the communication interface 113 of the hard disk recorder 101 enables the transmission of data among the monitor A 102, the monitor B 103 and the monitor C 104.

The monitor A 102 is able to publish or open the communication condition between the hard disk recorder 101 and the monitor A 102 itself, which is managed or controlled within the management portion 116, to the monitor B 103 and the monitor C 104, under the control of the controller 115, responding to the requests from the monitor B 103 and the monitor C 104. This is also same to the monitor B 103 and the monitor C 104. Also, the monitor A 102 is able, not only to make the communication condition within the management portion 116 published or readable on the monitor B 103 and the monitor C 104, but it also able to transmit the communication condition onto the monitor B 103 and the monitor C 104, under control of the controller 115. This is also same to the monitor B 103 and the monitor C 104. Accordingly, each of the monitors can grasp or hold the communication conditions of other monitors, mutually. Further, with an aid of control of the controller provided within the monitor, since it is possible to achieve the communication for obtaining a change or alternation upon the communication condition to the other monitor(s); therefore it is possible to change the method or the manner of reproducing the AV data depending upon the communication condition thereof.

Herein, with the communication condition in the present embodiment, it is indicated, for example, a kind of the AV data to be displayed on the monitor, the transmission rate of that AV data, a program for reproducing-sequence of the AV data, a connection time to the hard disk recorder 101, a prospected connection time, and a transmission capacity of the communication path, etc.

For example, in a case when trying to connect the monitor A 102 to the hard disk recorder 101, to which the monitor B 103 and the monitor C 104 have been already connected, a notice that a connection is made thereto is transmitted to the monitor B 103 and the monitor C 104, under the control of the controller 115, through the communication interface 114, the communication path 106, the communication interface 113 and the communication paths 107 and 108, thereby reporting a start of connection of the monitor A 102.

Also, in a case when the connection can be established, then the monitor A 102 brings the display portion 118 to display the information that the connection can be established and that the monitor B 103 and the monitor C 104 are connected with the hard disk recorder 101, under the control of the controller 115. Also, the monitor A 102 can set up the communication condition of itself, with using the input portion 119, by referring to the communication condition; such as, the kind of the AV data, the transmission rate of the AV data, and the program for reproducing-sequence of the AV data, etc., which are managed within the management portion, being owned in each of the monitor B 103 and the monitor C 104, respectively. On the other hand, the monitor A 102 is able to notice a limit upon the capacity of communication processing of the hard disk recorder 101, through obtaining the data from the control portion 111 of the hard disk recorder 101. With the present embodiment, it is possible to reduce the number of the AV data or change or alter the transmission rate of the AV data, by taking the monitor B 103 and the monitor C 104, which have been already connected with the hard disk recorder 101, into the consideration of a user, and therefore it is possible to increase the number of the monitors, which can be connected with the hard disk recorder 101.

Now, assuming that, for example, the hard disk recorder 101 has an enough capacity of reproducing two (2) kinds of the AV data located within the reservation portion 112 thereof, simultaneously, at the maximum picture quality, while it has already been outputting the AV data, separately, to the monitor B 103 and the monitor C 104, at the maximum picture quality, and therefore the hard disk recorder 101 is in the condition of being unable to provide an output of the AV data to other monitor any more, and also if the monitor A 102 issues a connection request to the hard disk recorder 101; then, a notice is made onto the monitor A 102 that it cannot be connected with, under the operation of the control portion 111 within the hard disk recorder 101.

In that instance, the user of the monitor A 102 selects one from the following selections, through operating upon the input portion 119:
(1) to end up the connecting operation, as it is;
(2) to peruse or read the information about the communication condition, which are managed within the management portion of the monitor B 103 and the monitor C 104; and
(3) to make a negotiation request to the user of the monitor B 103 or the monitor C 104.

In the case when the user of the monitor A 102 selects the end-up of the connection operation, then the connection operation is ended with the hard disk recorder 101. In a case when the user of the monitor A 102 selects the perusal of the information managed within the management portion of the monitor B 103 and the monitor C 104, then the information of the communication condition is displayed about the AV data, which are outputted to the monitor B 103 and the monitor C 104; such as, the kind of the AV data, the transmission rate of the AV data, and the program for reproducing-sequence of the AV data, the connection time to the hard disk recorder 101, and the prospected connection time, etc. The operation to be performed when conducting the negotiation request is made to the user of the monitor B 103 or the monitor C 104 will be mentioned later.

In that instance, for the user of the monitor A 102, it is possible to select one of the following selections, while perusing or reading the information about the communication condition, which is displayed on the display portion 118, through the operation on the input portion 119:
(1) to end up the connection operation to the hard disk recorder 101;
(2) to conduct the connection operation under the communication condition being same to that when reproducing the AV data in the monitor B 103 or the monitor C 104; and
(3) to make the negotiation request to the user of the monitor B 103 or the monitor C 104.

When the user of the monitor A 102 selects the end-up of the connection, then the connecting operation to the hard disk recorder 101 is ended. When she/he selects the connection under the condition, being same to the reproducing condition, in either one of the monitor B 103 or the monitor C 104, then the controller 115 notices that effect to the control portion 111 of the hard disk recorder 101. Upon receipt of that notice, the hard disk recorder 101 outputs the AV data selected, also to the monitor A 102, under the control of the control portion 111 thereof.

In a case where the user of the monitor A 102 selects to make the negotiation request between the user of the monitor B 103 or the monitor C 104, then the monitor A 102 transmits the contents of the request inputted through the input portion 119, via the communication interface 114, the communication path 106, the communication interface 113, and the communication paths 107 and 108, to the monitor B 103 or the monitor C 104, under the control of the controller 115. Upon receipt of the request, the monitor B 103 or the monitor C 104 selects one, i.e., either to allow the request or not (i.e., refuse), through the operation made on the input portion thereof. In a case when it is allowed, a notice of allowance is transmitted from the monitor of the user who permits that allowance, through the communication interface and the communication path(s), to the monitor A 102. And then, with using the controller of each of the monitors, the negotiation is started between the monitor A 102 and the monitor issuing that notice of allowance through the communication interface 113. In a case where every user refuses that request, the notice of refusal is transmitted to the monitor A 102, to be displayed on the display portion 118 thereof. The user of the monitor A 102, being refused from the request thereof, may ends up the connection operation to the hard disk recorder 101, or alternately may continue the connection operation under the condition, being completely same to that for reproduction of the AV data made in either one of the monitor B 103 or the monitor C 104.

However, the main electronic apparatus should not be restricted only to the hard disk recorder 101, and the electronic terminal devices or apparatuses also should not be restricted only to the monitors, as was mentioned in the above. Further, the communication paths 106 to 108 may be made up, in the place thereof, with using only one communication path, or a pair of paths; the one thereof is for excusive use of making communication between the apparatus and devices, and the other for excusive use of reproducing the recording data. Also, it may be achieved with using the wire or the radio wave; thus, the transmission method thereof is out of the question. Further, the communication paths 106 to 108 and/or the controller 115 may be installed within an inside of the monitor A 102, or it may be provided within a body separating from a housing of the monitor A 102, in the place thereof.

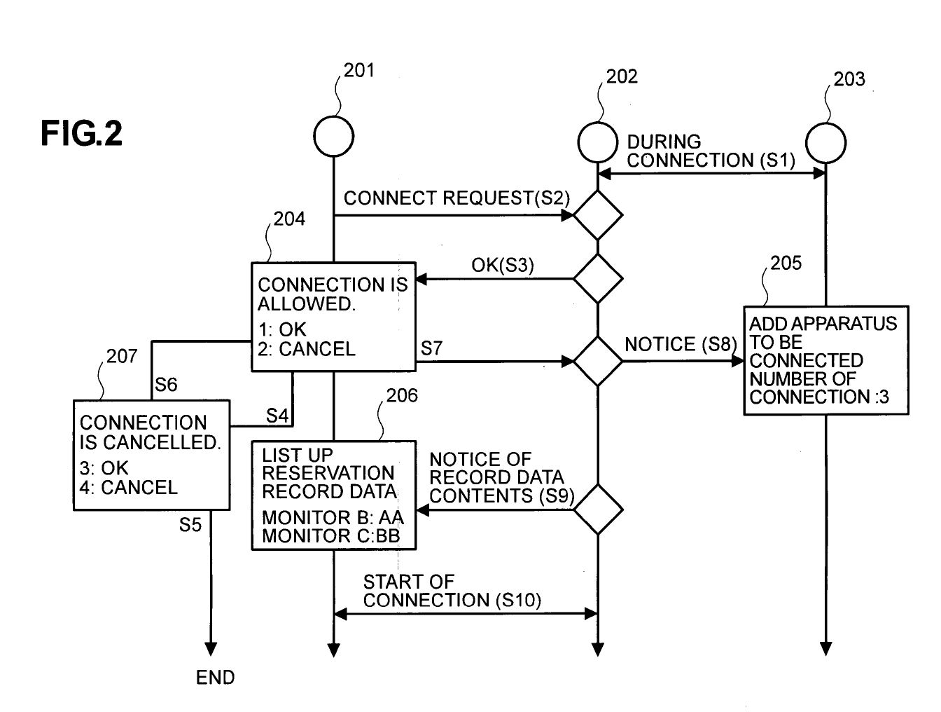

FIG. 2 shows one example of flows for showing a progress or procedure of the communication processes and also the display screens when conducting the communication processes within the network, according to the first embodiment. However, except for the cases of clearly mentioning thereabout in particular, the communication processes of the hard disk recorder 101 is conducted under the control of the control portion 111, while the communication processes of the monitor A 102 under the control of the controller 115. The monitor B 103 and the monitor C 104 are same to that of the monitor A 102.

In FIG. 2, a reference numeral 201 shows the progress and the display screens when conducting the communication processes on the monitor A 102, a reference numeral 202 the progress and the display screens when conducting the communication processes on the hard disk recorder 101, and a reference numeral 203 the progress and the display screens when conducting the communication processes on the monitor B 103 and the monitor C 104, which have already established the connection between the hard disk recorder 101 and are in the condition of displaying the AV data received from the hard disk recorder 101 on the display portions thereof.

When the hard disk recorder 101 has already been connected with the monitor B 103 and the monitor C 104, while the allowance is made up upon publication of the communication condition in the management portion within each of the monitors, thereby conducting the reproduction of AV data (step S1), the monitor A 102 transmits the connection request to an apparatus 202 (step S2). In that instance, in particular, when the control portion 111 within the hard disk recorder 101 determines not to exceed the limit in the capacity of the connections thereof, a notice of meaning that the connection is alright (i.e., connection OK) from the hard disk recorder 101 to the monitor A 102 (step S3), and then the monitor A 102 displays a screen 204 on the display portion 118 under the control of the controller 115.

The user of the monitor A 102 can selects “1: OK” or “2: Cancel”, while watching on the screen 204, through operating upon the input portion 119. In the case when the “2: Cancel” is selected, then the process advances to a step S4, wherein the monitor A 102 displays a confirmation screen 207 on the display portion 118, under the control of the controller 115.

Then, the user of the monitor A 102 may also selects “3: OK” or “4: Cancel”, while watching on a screen 207, through operating upon the input portion 119. In the case when the “3: OK” is selected, then the controller 115 of the monitor A 102 ends up the connecting operation (step S5). When the “4: Cancel” is selected, it turns back to the screen 204 (step S6), and therefore the user can make the selection, once again, through operation upon the input portion 119.

In a case where the user selects the “1: OK” while watching on the screen 204 on the monitor A 102, the start of the connection operation is noticed to the controller 111 of the hard disk recorder 101 from the monitor A 102. Also, passing through the hard disk recorder 101, a notice of increasing the number of terminals connected is transmitted to the monitor B 103 and the monitor C 104, thereby to be displayed on the screen 205 upon the display portions thereof (step S8). Both the monitor B 103 and the monitor C 104 display the screen 205 on the display portions owned by themselves, under the control of the controller. Also, the hard disk recorder 101 transmits data of the kind or sort of the AV data recorded on the HDD 112 to the monitor A 102 (step S9), and then the monitor A 102 displays the kind of the AV data receiving therefrom, on a screen 206.

While watching the screen 206, the user of the monitor A 102 can input a program for reproducing the AV data at her/his desire with using the input portion 119. When transmitting the program inputted to the hard disk recorder 101, the monitor A 102 transmits the AV data corresponding to the program inputted from the hard disk recorder 101 to the monitor A 102, thereby starting the connection between both of them (step S10).

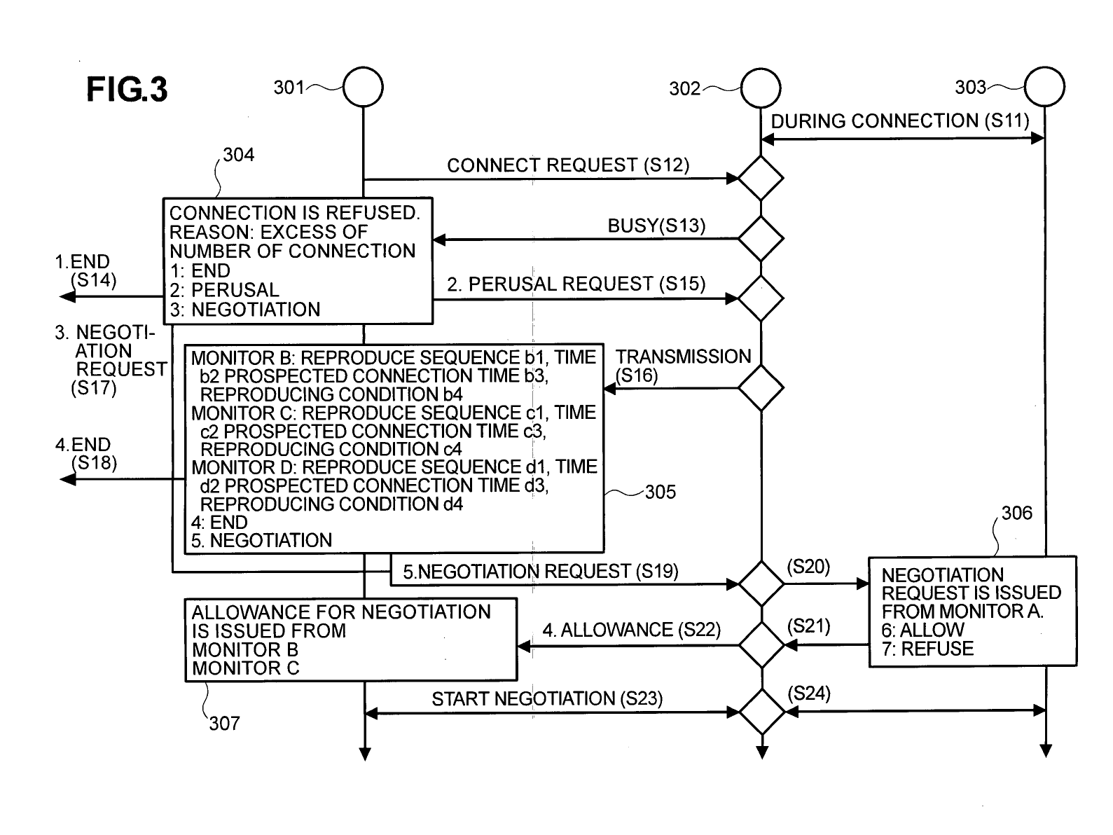

In FIG. 3, a reference numeral 301 depicts the display screens of the monitor A 102 on the progress of the communication process and when processing the communication process, 302 the display screens of the hard disk recorder 101 on the progress of the communication process and when processing the communication process, and 303 the display screens of the monitor B 103 and the monitor C 104 on the progress of the communication process and when processing the communication process, which have already established the connection with the hard disk recorder 101, thereby being in the condition of displaying the AV data received from the hard disk recorder 101 on the display portions thereof.

In a case when the hard disk recorder 101, the monitor B 103, the monitor C 104 and a monitor D 105 have already been connected with, while a set-up for allowing publication of the communication condition thereof is made in the each management portion within the monitors, thereby conducting the reproduction of the AV data (step S11), it is assumed that the user of the monitor A 102 transmits the connection request to the hard disk recorder 101 through operating upon the input portion 109. If the connection of the monitor A 102 thereto exceeds the processing capacity of the hard disk recorder 101, the hard disk recorder 101 transmits a “BUSY” notice to the monitor A 102 under the control of the control portion 111 (step S13).

Upon receipt of the “BUSY” notice, the monitor A 102 displays a screen 304 on the display portion 118 under the control of the controller 115. Since the connection to the hard disk recorder 101 is refused due to the fact that the connection exceeds the processing capacity of the hard disk recorder 101, then the user of the monitor A 102 must selects one among “1: End”, “2: Perusal” and “3: Negotiation”, while watching on the display screen 304 through operating upon the input portion 119.

In a case when the user of the monitor A 102 selects the “1: End”, then a process is conducted for ending up the connection to the hard disk recorder 101 (step S14).

In the case when the user of the monitor A 102 selects the “2: Perusal”, then the monitor A 102 transmits “2: Perusal request” to the monitor B 103, the monitor C 104 and the monitor D 105, through the hard disk recorder 101 (step S15). Upon receipt of the perusal request, the monitor B 103, the monitor C 104 and the monitor D 105 send back the publication information managed within the each management portion thereof, under the control of the controller (step S16). Upon receipt of the send-back notice or information, under the control of the controller 115, the monitor A 102 displays a screen 305 on the display portion 118; i.e., showing the sequential order, the connection times, the prospected connection time, the reproduction condition, etc., for example. While watching on this display screen 305, the user of the monitor A 102 can select to continue the connection under the condition, being completely same to that of the reproduction in any one of the monitor B 103, the monitor C 104 and the monitor D 105, or alternately to select one between “4: End” and “5: Negotiation”.

In the case where the user of the monitor A 102 selects the “4: End”, then the same process is conducted when selecting the “1: End” on the screen 304 (step S20).

When the user of the monitor A 102 selects the “3: Negotiation” or the “5: Negotiation” through operating upon the input portion 119, the negotiation request is transmitted through the hard disk reorder 101 to the monitor B 103, the monitor C 104 and the monitor D 105 (steps S17, S19 and S 20). Upon receipt of the negotiation request, the monitor B 103, the monitor C 104 and the monitor D 105 display a screen 306 on the display portions thereof, under control of the controller. While watching on the screen 306, the users of the monitor B 103, the monitor C 104 and the monitor D 105 may select one, between “6: Allowance” and “7: Refusal”. In the case where any one of the users of the monitor B 103, the monitor C 104 and the monitor D 105 selects the “6: Allow”, the monitor B 103, the monitor C 104 or the monitor D 105 transmits the allowance notice to the monitor A 102 through the hard disk recorder 101 (steps S21 and S22). Upon receipt of the allowance notice, the monitor A 102 displays a screen 307 on the display portion 118 under control of the controller thereof. And then, the monitor A 103 starts the negotiation between the monitor issuing the allowance notice, mutually, through inputting an intention of the user via the input portion thereof (steps S23 and S24).

As a result of the negotiation, if the user of the monitor allowing the negotiation request accepts to stop an output of the AV data, for example, or to change the condition of reproducing (i.e., the communication condition), such as, reducing the picture quality of the AV data, etc., then that alternation on the communication condition is noticed from the monitor accepting the negotiation request to the hard disk recorder 101. Also, accompanying the alternation on the reproduction condition (i.e., the communication condition) of the monitor accepting that negotiation request, the information is notices from the monitor A 102 to the hard disk recorder 101; such as, the kind of AV data to be received from the hard disk recorder 101, and the reproduction condition (i.e., the communication condition), for example. Upon receipt of the notice, the control portion 114 of the hard disk recorder 101 renews the contents of the reproduction condition (i.e., the communication condition) managed within the management portion 115 thereof. And the hard disk recorder 101 transmits the AV data to the monitor A 102 upon the basis of the reproduction program transmitted thereto. In this manner, the connection is started between the monitor A 102 and the hard disk recorder 101.

According to the embodiment 1, it is possible to peruse and notice the communication condition, so as to obtain communication upon this communication condition, thereby improving the usability thereof.

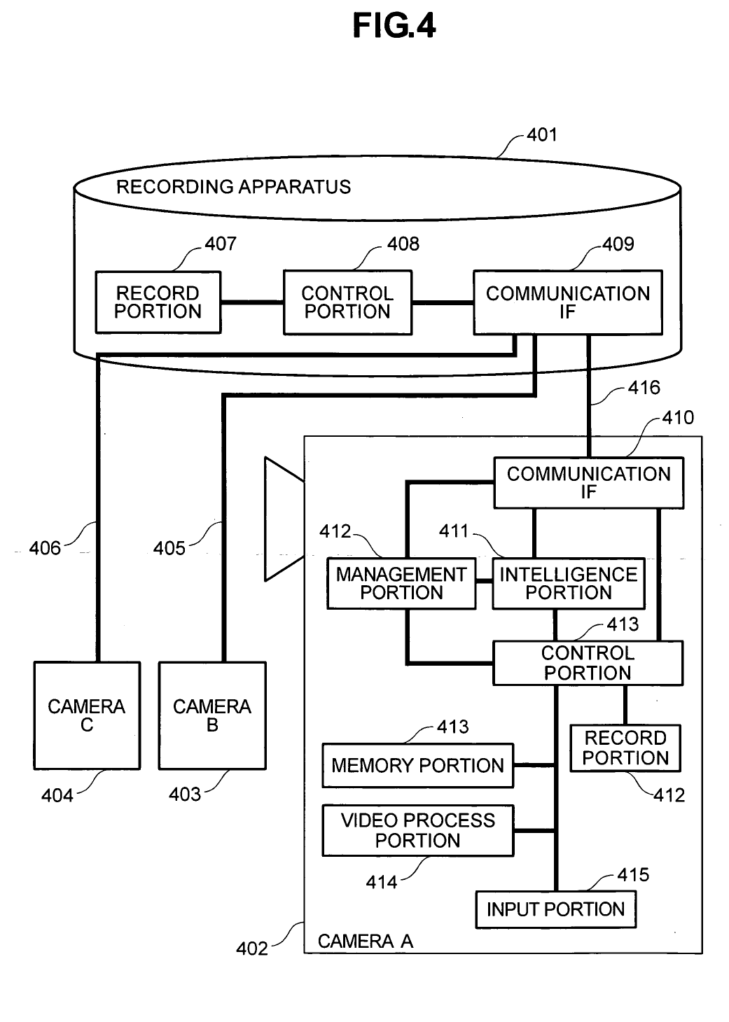

FIG. 4 is a view show showing the structure for building up an observatiing or watching network, according to the present embodiment.

In this FIG. 4, a reference numeral 401 is a recording apparatus having a communication function, making up a main part of the communication, 402 a camera A, being connectable with the apparatus 401 and having a communication function, 403 and 404 cameras, each of which also has a function same to that of the apparatus (i.e., the camera) 402, and 404 to 406 communication paths for connecting the apparatuses 402 to 404 with the apparatus 401. Further, a reference numeral 407 is a record portion, 408 is a control portion for controlling the apparatus 401, 409 a communication interface, through which the apparatus 401 connects with a plural number of apparatuses, so as to receive the recording data, thereby enabling the communication between those apparatuses, 409 a communication interface, through which the recoding data is transmitted from the apparatus 402 to the apparatus 401, thereby enabling the communication between those apparatuses, 411 an artificial intelligence (AI) portion storing an artificial intelligence (AI) function therein, 412 a management portion for managing management data therein, such as, the recording condition, the position information, etc., of the camera A 402, 412 a recording portion, 413 a memory portion, 414 a video processing portion for processing the video recorded, and 415 a data input portion, through which the apparatus 402 conducts picking up of an image and recording thereof.

The recoding apparatus 401 has a communication function, and therefore being able to connect with and communicate with the plural number of the cameras, through the communication interface 409. The camera A 402, the camera B 403 and the camera C 404 are also connected with, through the communication interfaces 409 and 410 and also the communication paths 404, 405 and 416; therefore, the picked-up image data is transmitted to the recording apparatus 401, to be recorded onto the record portion 407.

On the camera A 401 is installed the AI function, therefore it can determine an object to be picked up the image thereof by itself, and also can change the object to be picked-up the image thereof and/or the direction thereof, etc., depending upon the situation, through operating or controlling upon the control portion 413. With managing this image-pickup condition always within the management portion 412, it is possible to see the picked-up image from other cameras through the communication interface 410. Also, with provision of the AI portion 411, it is possible to acknowledge or discriminate on which one of the camera B 403 and the camera C 404 is connected to the recording apparatus 401. The camera B 403 and the camera C 404 also have the same structure thereto.

While every camera is picking up pictures, thereby conducting the watching, when acknowledging an occurrence of an event, then first, the camera A 402 changes the image-pickup condition thereof, so as to pick up that event occurring, the IC portions of the camera B 403 and the camera C 404 also grasp or hold the image pick-up condition of that apparatus 402, always, upon the basis of a space, on which the image was taken by the camera A 402 before occurring that event. Accordingly, accompanying the changes of the condition of the camera A 402, for each of those cameras, it is possible to grasp the image-pickup condition, thereby to change a mode and/or the image-pickup direction, such as, through changing a mode of image-pickup of each of the camera B 403 and the camera C 404 into a wide-range within an image-pickup area, etc.; i.e., following up the watching on the space, the image of which has been taken by the camera A 402 before the time when that event occurs. In this manner, for each of the cameras, it is possible to change the image-pickup condition thereof, mutually, depending upon time-to-time changes of the condition thereof.

Also, even in a case when an abnormal situation occurs, while each camera picking up an image and recording of the data is conducted into the recording apparatus 401, therefore being in the condition of impossible to make a control upon the recording data, however each of the cameras receives those situations or conditions from the control portion 408 of the recording apparatus 401, and therefore it is possible to change the condition thereof; such as, to record the recording data into the record portion which the camera owns therein, etc., for example.

According to the present embodiment, it is possible to record the data picked up by each of the cameras into the record portion 407 of the recording apparatus 401, while deleting the data in excess, such as, the contents duplicated therebeween, etc., or to build up the observation network with a less number of those cameras, thereby reducing the number of the cameras, and also enabling an effective use of the recording apparatus 401.

The present invention may be embodied in other specific forms without departing from the spirit or essential feature or characteristics thereof. The present embodiment(s) is/are therefore to be considered in all respects as illustrative and not restrictive, the scope of the invention being indicated by the appended claims rather than by the forgoing description and range of equivalency of the claims are therefore to be embraces therein.

1. An electronic terminal apparatus, for processing information provided from a recording/reproducing apparatus connected thereto, comprising:
a communication interface being configured to send information to said recording/reproducing apparatus and to receive information from said recording/reproducing apparatus;
a display portion being configured to display the information provided from said recording/reproducing apparatus; and
a control portion being configured to control said electronic terminal apparatus, wherein:
when connecting said electronic terminal apparatus to said recording/reproducing apparatus, to which other electronic terminal apparatus is already connected, said control portion receives information relating to a communication condition between said recording/reproducing apparatus and said other electronic terminal apparatus connected thereto, thereby displaying the information relating to said communication condition on said display portion.

2. The electronic terminal apparatus, as described in the claim 1, wherein:
when the information cannot be sent from said recording/reproducing apparatus to said other electronic terminal apparatus, said control portion receives information of indicative that the information cannot be sent from said recording/reproducing apparatus, thereby displaying information of indicative that said information cannot be sent, on said display portion.

3. The electronic terminal apparatus, as described in the claim 1, wherein:
said control portion receive information of indicative that said other electronic terminal apparatus is already connected thereto, and displays the information of indicative that said other electronic terminal apparatus is already connected thereto, on said display portion.

4. The electronic terminal apparatus, as described in the claim 1, wherein:
information can be transmitted between said other electronic terminal apparatus through a communication interface of said recording/reproducing apparatus.
